(19) United States
(12) Patent Application Publication
(10) Pub. No.: US 2019/0001364 A1
(43) Pub. Date: Jan. 3, 2019

(54) METHOD FOR THERMAL SPRAY DEPOSITION OF A COATING ON A SURFACE AND APPARATUS

(71) Applicant: TURBOCOATING S.P.A., Solignano (IT)

(72) Inventors: Nelso ANTOLOTTI, Solignano (IT); Mauro ANTOLOTTI, Solignano (IT); Luigi COPPELLETTI, Solignano (IT)

(21) Appl. No.: 16/063,248

(22) PCT Filed: Dec. 16, 2016
(86) PCT No.: PCT/IB2016/057703

§ 371 Date: Jun. 16, 2018

(30) Foreign Application Priority Data
Dec. 16, 2015 (IT) ITUB20159465

(51) Int. Cl. B05B 13/04; B05B 15/62; B05B 7/20; C23C 4/134; C23C 4/129

(52) U.S. Cl. CPC B05B 13/0431; B05B 15/62; B05B 13/0405; C23C 4/134; C23C 4/129; B05B 7/205

(57) ABSTRACT

Method of deposition of a coating on a surface of a workpiece, working with at least one deposition device, or torch, of Thermal Spray type, controlled by an associated motor. It is contemplated to perform the deposition step by configuring the torch so as to create two concurrent movements, of which a first movement along a linear path on the surface area to be coated; a second oscillation movement according to an axis of rotation coaxial with said advancement direction; this allows increasing the spray pattern of the thermal spray torch at each stroke resulting in a reduction of the relative movement speed of the torch itself.

### SCOPE OF THE INVENTION

The present invention relates to a particular system of deposition of coating material in “thermal spray” technologies.

The possibility of applying a coating or a surface treatment to mechanic& components and obtain functional properties that would not be obtained with the substrate and coating materials taken individually is widespread.

An example are the materials exhibiting good mechanical strength properties but they have a non-optimal behavior when wear or corrosion phenomena are present. In these cases, a surface treatment or a coating is applied to the surface of the component in order to improve the anti-wear or anti-corrosion properties.

There are many deposition technologies, which differ in the features of the coating to be obtained and can be classified according to different criteria such as, for example, the thickness of the coatings that can be obtained and the starting physical state of the materials used for coating.

Among these technologies, the Thermal Spray technologies have taken on particular importance due to the large variety of materials usable for the deposition and the features of the coatings that can be obtained. The principle of Thermal Spray technologies consists in administering energy to the material to be deposited until it is brought to melting and then transport it toward the substrate to be coated.

Among the Thermal Spray technologies we may mention:
Combustion Flame Spray,
Arc Flame Spray,
Plasma Spray,
HVOF (High Velocity Oxygen Fuel),
Cold Spray.

The invention is not only limited to the above, but also to all technologies involving thermal spraying.

Since the above Thermal Spray processes are essentially unidirectional, the torch is normally moved by a robot arm or CNC, so that it can follow quite complex profiles.

The torch used is generally operated with direct current. Briefly, the cathode has a toroidal shape and is typically made of copper with possible insert in tungsten in order to improve the surface features, while the anode of cylindrical shape can be made of copper; both are internally water-cooled. In order to cause the formation of the plasma, an electric arc is made to strike between the cathode tip and the anode inner region. The plasma is continuously supported by the supply of new plasmagenic gas; once fully operating, the plasma takes the form of a cylindrical flame exiting from the nozzle. The temperature reached by the plasma is of the order of 9000÷20000 K.

When the plasma reaches in the vicinity of the nozzle, the ions and the electrons tend to recombine, thus promoting a high level of enthalpy. The powder is radially introduced in this area, usually by means of a carrier gas; it melts due to the energy supplied by the recombination of positive ions and electrons, it is conveyed by the flame and accelerated against the substrate, against which it strikes and proceeds to rapid solidification.

Based on the parameters considered above, different values of the energy required to melt the particles can be obtained.

### PRIOR ART

The traditional process performs the coating by moving the torch and creating a path of the “fretted” type, i.e. forward and backward, by means of a plurality of rectilinear swipes adjacent to each other.

In order to do so, the robot or CNC must maintain a certain speed, actually quite fast, of the order of 50-60 meters per minute, so as to prevent the torch from depositing too much material (thereby limiting the deposit thickness) in addition to the overheating of the surface/coated workpiece.

Drawbacks:
a first drawback is the fact that when large and/or irregular surfaces are coated, there is a certain difficulty to follow and maintain the robot at the required speed, which can result in greater stress and possible breakage or requests for intervention.
a second drawback is related to the process, since the direction change areas must stand outside of the surface/workpiece being coated, precisely because of the high speeds required to the robot and relative reversal inertias, with consequent waste of material during such a reversal.

### DESCRIPTION AND ADVANTAGES OF THE INVENTION

An object of the present invention is to provide a method and a system which eliminates the above drawbacks and which allows carrying out thermal spray coatings on inner and/or outer surfaces of workpieces, with a simple, rational and cost-effective solution.

In more detail, the object is to provide a system that allows increasing the spray pattern of the thermal spray torch at each swipe with consequent reduction of the relative speed of displacement of the torch itself.

These and other objects are achieved with the features of the invention described in the independent claim 1. The dependent claims describe preferred and/or particularly advantageous aspects of the invention.

In particular, one embodiment of the present invention, instead of imposing a single and high linear deposition speed of the material to be deposited, provides for configuring the robot or the CNC so that it has a slow linear advancement speed (in processing) and at same time, an oscillation is imparted to the jet of material to be deposited.

The above oscillation occurs according to a plane perpendicular to the advancement direction, thus according to an axis coincident with the linear advancement one and against the surface to be coated.

With this solution, the overall coating speed, defined by the oscillation of the material cooperating with the advancement imposed to the torch by the robot or CNC, has ameliorative effects in many aspects: in particular, the combination between the linear path defined by the low speed advancement of the robot and the corresponding oscillation of the deposition material dispensed through the torch nozzles, creates a spray pattern (stripe) of product deposited, much wider than that deposited with a single non-oscillating swipe, and at the same time preserves the sprayed thickness within the required limits.

According to possible embodiments, the “combined” coating defined by the invention, i.e. deposition with linear advancement and respective oscillation according to a rotation axis coinciding with said advancement direction, provides that:
in a first embodiment, the oscillation takes place with dedicated motor configured so as to put in rotation the torch head, and wherein the coating material dispensing nozzles are fixed with respect to said torch; a motion transmission mechanism is suitably provided between said motor and the torch head,
in a second embodiment, the oscillation takes place with a movement system of the torch head nozzles; the torch remains fixed in position with respect to the motor, while the latter is mechanically associated with the relative nozzles which thus oscillate according to the invention; moreover, a motion transmission mechanism is suitably provided between said motor and the torch head,
in a third embodiment, especially in the case of HVOF type torches, the oscillation is applied both to the complete torch and to the nozzles, always through appropriate motion return mechanisms.

### ADVANTAGES

1) Better control of the coating thickness, with greater precision than a conventional torch, which also allows carrying out the process on (both inner and outer) surfaces of shaped workpieces and at the same time impart greater control to the robot,

2) Reduction of the localized temperature allowing for continuous spraying without interruption,

3) Saving time for spraying the workpiece,

4) Saving on consumable material (electrodes, nozzles, powder, wire, etc.), since it is not necessary to remove the workpiece from the deposition torch,

5) Less wear of the deposition torch movement robots.

Said objects and advantages are all achieved by the Thermal Spray deposition method of a coating on a surface and apparatus, object of the present invention, which is characterized by the appended claims.

### BRIEF DESCRIPTION OF THE FIGURES

This and other features will become more apparent from the following description of some of the configurations, illustrated purely by way of example in the accompanying drawings.

FIG. 1: shows a conventional Thermal Spray deposition torch, according to the prior art, with the denomination of the component parts of the apparatus,

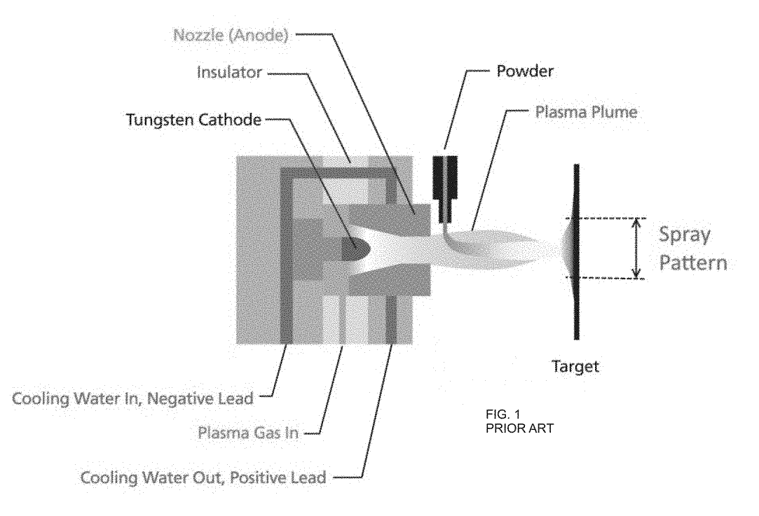

FIG. 2: shows an example of application of the claimed invention, with oscillating system on a plasma torch for thermal spray; the example is not limiting, the system may be applied to other thermal spray technologies (APS, HVOF, Flamepray, Arcspray, etc.).

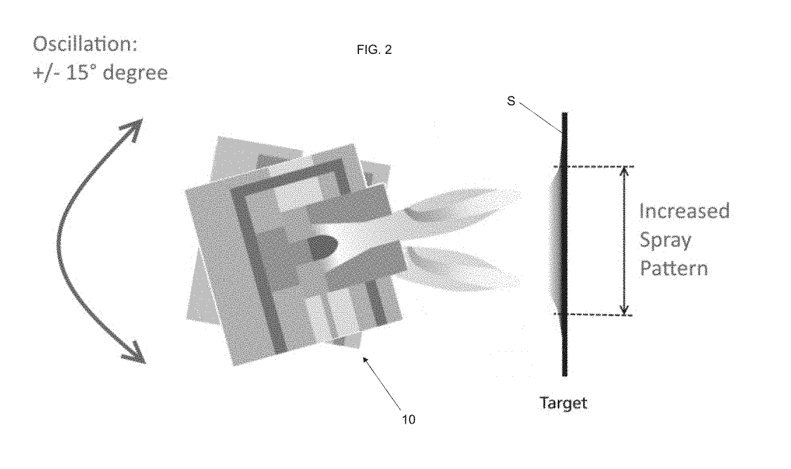

FIG. 3: shows the operational step of the torch embodying the method of the invention.

### DESCRIPTION OF THE INVENTION

With particular reference to the figures, reference numeral 10 indicates a Thermal Spray torch comprising spray heads and nozzles 11 through which a flow F comes out which conveys coating material with filling R is made on surface S of the workpiece.

The torch 10 head is mechanically associated with a motor 20 able to create a rotation according to a longitudinal axis AA which will correspond, in operating conditions, to the linear advancement axis of the torch itself.

In the example, motor 20 is configured to impart a rotation (i.e. an oscillation) of +/−15°, however, this value is not binding for the requested protection and can be increased or reduced according to the requirements.

The torch oscillation allows increasing the spray pattern and thereby reduce the translation speed, this allows controlling the position with higher precision.

Motor 20 together with a mechanical motion transmission mechanism (not shown) constitutes an oscillating system which allows carrying out the operating step according to the invention.

Motor 20 is controlled by an electronic feedback system (not shown) which allows setting a speed and keeping it stable during use.

According to possible embodiments, the torch is adaptable to the different working conditions, since the oscillating system described and claimed herein may be used for both inner and outer coating torches.

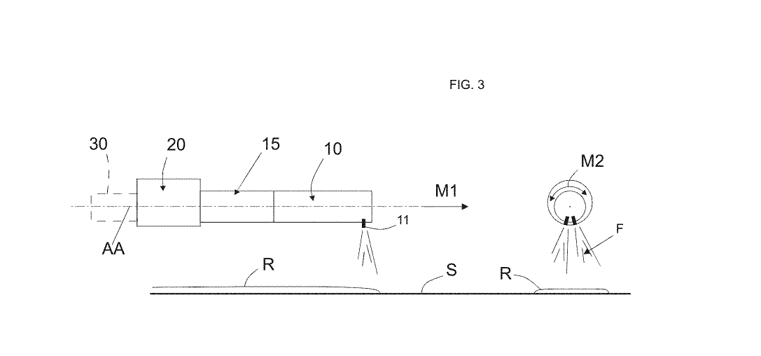

To this end, the torch may be installed on an arm/extension, indicated with reference numeral 15 in FIG. 3, which can be of different length depending on the application and the workpiece to be processed.

In this case, all the tubes/cables necessary to the operation of the torch are contained within the metallic extension 15 of the oscillating arm to protect them from exposure to high temperatures.

The unit described above, namely motor 20, possible arm 15 and torch 10, is preferably installed at the end of an anthropomorphic robot 30, or a similar handling system and arranged so as to carry out the coating against the surface of the workpiece, orienting its nozzles toward said surface and allow the movement along the rectilinear direction M1, or in any case a direction that maintains a predetermined distance from surface S to be coated.

The thermal spray torch 10 for generating the flame used for the thermal coating is connected to a standard control system and the oscillating unit does not interfere with the thermal spray system.

In essence, the head of the thermal spray torch is designed to be installed on an oscillating support, where the oscillating support is motorized and allows a +/−15° oscillation; a motor speed control system and one or more motion transmission mechanisms on the head and/or the nozzles are also provided, as said above.

In summary, with particular reference to the figures and to the description herein, the following is claimed:
the method for depositing a coating on a surface S of a workpiece, the method working with at least one device 10, a Thermal Spray deposition torch; the method provides for carrying out the deposition step by configuring the torch so as to create two concurrent movements, of which:
   A first movement M1 along a linear path on the area of the surface to be coated; said first movement being carried out by the robot 30 or equivalent system;
   A second movement M2 making an oscillation according to a rotation axis (AA) coaxial with said advancement direction M1; said second movement M2 being carried out by a further associated motor 20.
In an embodiment of the present invention, said second movement prepares the oscillation of the torch 10 head.
In an embodiment of the present invention, said second movement prepares the oscillation of only the nozzles 11 of the torch head.
In an embodiment of the present invention, said second movement prepares the oscillation of both the full torch and the nozzles.
Said second movement is an oscillation of +/−30°, preferably +/−15°, with respect to a plane perpendicular to the surface to be coated.
The Thermal Spray deposition torch is also claimed, mechanically associated with a movement apparatus and adapted to perform coatings on a surface of a workpiece through relative nozzles dispensing the material:
   wherein the torch comprises at least one motor mechanically associated with said head; the motor being configured to impart, by means of an intermediate mechanism, an alternating oscillation of the torch head, according to an axis perpendicular to the direction of the nozzles, and thereby to the output of the filling material; the coating material dispensing nozzles are fixed with respect to the torch head.
   Wherein the torch comprises at least one motor mechanically associated with said nozzles; the motor being configured to impart, by means of an intermediate mechanism, an alternating oscillation of said nozzles, according to an axis perpendicular to the dispensing direction of the material from said nozzles; the torch remains fixed in position with respect to the motor.
   Wherein the torch comprises at least one motor mechanically associated both with said head and with said nozzles; the motor being configured to impart, by means of an intermediate mechanism, an oscillation to both components, according to an axis perpendicular to the dispensing direction of the material from said nozzles.
   An arm/extension 15 is provided between said motor and said torch which can be of different length depending on the application and on the workpiece to be worked; the tubes/cables necessary for the operation of the torch are contained within extension 15.

1. A method for depositing a coating on a surface of a workpiece, the method working with at least one device, such as a Thermal Spray deposition torch, controlled by a robot; the method comprising carrying out the deposition step by configuring the torch so as to create two concurrent movements, of which:
a. A first movement (M1) along the area of the surface to be coated; said first movement being carried out by the robot or equivalent system;
b. A second movement (M2) of oscillation according to a rotation axis (AA) coaxial with said advancement direction; said second movement being carried out by a further associated motor.

2. The method according to claim 1, wherein said second movement prepares the oscillation of the torch head.

3. The method according to claim 1, wherein said second movement prepares the oscillation of only the nozzles of the torch head.

4. The method according to claim 1, wherein said second movement prepares the oscillation of both the full torch and of the nozzles.

5. The method according to claim 1, wherein said second movement is an oscillation of +/−30°, with respect to a plane perpendicular to the surface to be coated.

6. A torch for the deposition of surface coatings by thermal spray technologies, the torch mechanically associated with a movement apparatus and adapted to perform coatings (R) on a surface (S) of a workpiece through one or more nozzles dispensing the material; the torch comprising at least one motor mechanically associated with the head thereof; the motor being configured to impart, by an intermediate mechanism, an alternating oscillation of the torch head, according to an axis perpendicular to the direction of the nozzles, and thereby to the output of the filling material; the coating material dispensing nozzles are fixed with respect to the torch head.

7. A torch for the deposition of surface coatings by thermal spray technologies, the torch mechanically associated with a movement apparatus and adapted to perform coatings (R) on a surface (S) of a workpiece through one or more nozzles dispensing the material; the torch comprising at least one motor mechanically associated with said nozzles; the motor being configured to impart, by an intermediate mechanism, an alternating oscillation of said nozzles, according to an axis perpendicular to the output direction of the material from said nozzles; the torch remains fixed in position with respect to the motor.

8. (canceled)

9. A Thermal Spray deposition torch according to claim 1, wherein an arm/extension is provided between said motor and said torch which can be of different length depending on the application and on the workpiece to be worked; the tubes/cables necessary for the operation of the torch are contained within the extension.

10. The method according to claim 1, wherein said second movement is an oscillation of +/−15°, with respect to a plane perpendicular to the surface to be coated.
